(19) United States
(12) Patent Application Publication
(10) Pub. No.: US 2013/0346395 A1
(43) Pub. Date: Dec. 26, 2013

(54) Method for Internet users to mark resources to be displayed or executed from a result list

(71) Applicant: NING ZHU, MIAMI, FL (US)

(72) Inventor: NING ZHU, MIAMI, FL (US)

(21) Appl. No.: 13/918,139

(22) Filed: Jun. 14, 2013

Related U.S. Application Data
(60) Provisional application No. 61/661,855, filed on Jun. 20, 2012.

(51) Int. Cl. G06F 17/30

(52) U.S. Cl. CPC G06F 17/30864
USPC 707/722

(57) ABSTRACT

This invention provides a method for users to mark resources on the Internet so that when the marked resources on the Internet are included in a result list from an Internet service, such as a search engine or bookmark service to the user, they will be displayed or executed.

### CROSS-REFERENCE TO RELATED APPLICATIONS

This patent application claims the benefit of U.S. Provisional Patent Application 61/661,855 filed Jun. 20, 2012 entitled “Method for Internet users to mark resources to be displayed or executed from a result list”.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates to a method for users to mark resources on the Internet so that when the resources are included in a result list from an Internet service, such as a search engine or bookmark service, they will be displayed or executed directly.

2. Description of the Related Art

Originally, search engines and bookmark services on the Internet worked in such a way that a result list was provided to users who then chose what they needed from the list.

Recently, a better method has been realized. This method provides a result list, displays a resource, and executes it for users directly. For example, when users input “1+1” in Google's search box, the result “2” is displayed at the top of the result list. When users input “weather Fort Lauderdale”, the weather in Fort Lauderdale is displayed at the top of the result list.

So far, marking resources to be displayed or executed directly from a result list has been done by a very limited group of people, for example, those people in search engine services. As a result, it is very often the case that there are no enough such resources to meet the user's need. Currently, there is no any method for users to mark the resources for personal use.

Therefore, a new method, which allows Internet users to mark or unmark resources for display or execution from a result list to the user, is needed.

### SUMMARY

This present invention provides a method for users to mark resources on the Internet so that when the marked resources on the Internet are included in a result list from an Internet service, such as a search engine or bookmark service to the user, they will be displayed or executed directly.

### BRIEF DESCRIPTION OF THE DRAWING

Not Applicable.

### DESCRIPTION OF THE PREFERRED EMBODIMENTS

The following is a detailed description of the preferred embodiments.

### Example 1

Marking a game resource for directly playing from the result list.

There are two users: user A and user B. At first, none of the resources are marked. When the two users input “chess” into a search engine, the search engine finds http://example.chess along with 19 other resources and displays links to them as a list to both users. Then, we assume that user A marks the resource http://example.chess. When the two users input “chess” into a search engine again, the resulting list for both users is still the same. However, for user A, in addition to returning the result list, the chess program found in http://example.chess is directly executed too because user A has already marked the resource.

### Example 2

Marking a video resource for directly playing from the result list.

There are two users: user A and user B. At first, none of the resources are marked. When the two users input “My Heart Will Go On” into a search engine, the search engine finds “Céline Dion—My Heart Will Go On—YouTube” along with 19 other resources and displays links to them as a list to both users. Then, we assume that user A marks the resource “Céline Dion—My Heart Will Go On—YouTube”. When the two users input “My Heart Will Go On” into a search engine again, the resulting list for both users is still the same. However, for user A, in addition to returning the result list, the video resource “Céline Dion—My Heart Will Go On—YouTube” is directly played too because user A has already marked the resource.

### Example 3

Marking all video resources of a website for directly playing from the result list.

There are two users: user A and user B. At first, none of the resources are marked. When the two users input “My Heart Will Go On” into a search engine, the search engine finds “Céline Dion—My Heart Will Go On—YouTube” along with 19 other resources and displays links to them as a list to both users. Then, we assume that user A marks the website to which the resource “Céline Dion—My Heart Will Go On—YouTube” belong. When the two users input “Power Of Love” into a search engine again, the search engine finds “Huey Lewis—The Power Of Love—YouTube” along with 19 other resources and displays links to them as a list to both users. However, for user A, in addition to returning the result list, the video resource “Huey Lewis—The Power Of Love—YouTube” is directly played too because both the resource “Céline Dion—My Heart Will Go On—YouTube” and the resource “Huey Lewis—The Power Of Love—YouTube” belong to same website and user A has already marked the website.

### Example 4

Unmarking a game resource.

The resource http://example.chess is marked for display or execution from the result list for user A. Now we assume that user A unmarks the resource. Thus when user A inputs “chess” into a search engine again, the search engine finds http:example.chess along with 19 other resources and displays links to user A, but the program from http://example.chess is not executed anymore.

We claim:

1. A method comprising the submethods of:
a) marking resource, for a user to mark or unmark one or more Internet resource(s);
b) searching resource comprising the steps of:
ba) obtaining a search query from said user;
bb) providing a resource link list based on said search query to said user;
bc) providing the content of said marked resource to said user if said marked resource is included in said resource link list.

2. The method of claim 1, wherein said Internet resource is selected from the group, consists of htm file, html file, asp file, aspx file, php file, rss file, atom file, rdf file, xml file, jsp file, mp3 file, mp4 file, wma file, rm file, avi file, way file, mid file, mpeg file, mjpeg file, m-jpeg file, bmp file, gif file, dib file, jpg file, jpeg file, ppt file, pdf file, swf file, flv file and dwf file.

3. The method of claim 1, wherein the step of bc) in the submethod of b), further comprises:
bca) displaying the content of said Internet resource in the browser in the computer used by said user.

4. The method of claim 1, wherein the step of bc) in the submethod of b), further comprises:
bca) utilizing a software program to play or display the content of said Internet resource in the computer used by said user.

5. The method of claim 1, wherein said Internet resource is web page;
and the step of bc) in the submethod of b), further comprises:
bca) displaying the web page of said Internet resource in the browser in the computer used by said user.

6. The method of claim 1, wherein the submethod of a), is provided by an Internet service.

7. The method of claim 6, wherein the submethod of a), is further provided by one or more web page component(s) in the web page of said Internet service;
and said web page component is selected from the group consisting of checkbox, radio button, text box, other functional buttons and link;
and said web page component also provides a function selected from the group consisting of like, share, bookmark, collect, review, comment, rate and rank;
and the submethod of a) further comprises the steps of:
aa) said user using said web page component for said Internet resource;
ab) utilizing said function for said Internet resource;
ac) marking or unmarking said Internet resource.

8. The method of claim 1, wherein the submethod of a), is further provided by one or more component(s) in the browser in the computer used by said user;
and said component is selected from the group consisting of plug-in, add-on and extension.

9. The method of claim 8, wherein said component, also provides a function selected from the group consisting of like, share, bookmark, collect, review, comment, rate and rank;
and the submethod of a) further comprising the steps of:
aa) said user using said component for said Internet resource;
ab) utilizing said function for said Internet resource;
ac) marking or unmarking said Internet resource.

10. The method of claim 1, wherein the submethod of b), is provided by an Internet service.

11. The method of claim 10, wherein the step of bc) in the submethod of b), further comprises:
bca) embedding a player in a web page of said Internet service;
bcb) displaying said web page in the browser in the computer used by said user;
bcc) utilizing said player play or display said Internet resource.

12. The method of claim 10, wherein said Internet resource, is selected from the group consisting of Widget and Gadget;
and the step of bc) in the submethod of b), further comprises:
bca) embedding said Internet resource in a web page of said Internet service;
bcb) displaying said web page in the browser in the computer used by said user.

13. The method of claim 1, wherein both the submethod of a) and the submethod of b), is provided by one Internet search engine;
and said resource link list in the submethod of b) is the search result list based on said search query.

14. The method of claim 1, wherein the submethod of a), further comprises the submethods of:
aa) providing account management service for said user;
ab) saving said Internet resource mark information set by said user into the account of said user;
and the step of bc) in the submethod of b) further comprises:
bca) obtaining saved said Internet resource mark information from the account of said user;
bcb) obtaining one or more marked resource(s) from said resource link list based on said Internet resource mark information obtained from the step bca);
bcc) providing the content of said marked resource obtained from the step bcb) to said user.

15. The method of claim 6 and the method of claim 10, wherein the submethod of a), further comprises the submethods of:
aa) enabling the cookies in the browser in the computer used by said user;
ab) generating a cookie which uniquely identifies said user;
ac) saving said Internet resource mark information with said cookie into a database in said Internet service in the submethod a);
and the step of bc) in the submethod of b) further comprises
bca) retrieving said Internet resource mark information based on said cookie from said database in said Internet service in the submethod a);
bcb) obtaining one or more marked resource(s) from said resource link list based on said Internet resource mark information retrieved from the step bca);
bcc) providing the content of said marked resource obtained from the step bcb) to said user.

16. The method of claim 1, wherein the submethod of a), is provided by a program in the computer used by said user.

17. The method of claim 1, wherein the submethod of b), is provided by a program in the computer used by said user.

18. The method of claim 1, wherein the submethod of a), further comprises the step of:
aa) Marking or unmarking the web site to which said Internet resources belong;
and the step of bc) in the submethod of b) further comprises
bca) obtaining all resources which belong to said marked web site from said resource link list;
bcb) providing the content of said resources obtained from the step bcb) to said user.
